(19) United States
(12) Patent Application Publication
(10) Pub. No.: US 2017/0022834 A1
(43) Pub. Date: Jan. 26, 2017

(54) High pressure compressor diffuser for an industrial gas turbine engine

(71) Applicant: John A. Orosa, Palm Beach Gardens, FL (US)

(72) Inventor: John A. Orosa, Palm Beach Gardens, FL (US)

(21) Appl. No.: 15/146,036

(22) Filed: May 4, 2016

Related U.S. Application Data
(60) Provisional application No. 62/195,509, filed on Jul. 22, 2015.

(51) Int. Cl. F01D 9/04; F01D 15/10; F01D 5/18; F01D 25/12; F02C 3/04; F02C 3/14

(52) U.S. Cl. CPC F01D 9/041; F02C 3/04; F02C 3/14; F01D 5/18; F01D 25/12; F01D 15/10; F05D 2220/32; F05D 2240/35; F05D 2240/24; F04D 29/321

(57) ABSTRACT

A gas turbine engine with an air cooled turbine part in which spent cooling air for the turbine part is discharged into the combustor instead of into the hot gas stream of the turbine in order to increase efficiency of the engine. Turbine rotor blades and stator vanes are cooled. The spent cooling air is passed into a diffuser located between the HPC outlet and the combustor inlet where the spent cooling air is discharged along the inner and outer endwalls of the diffuser in directions substantially parallel to the inner and outer diffuser endwalls and at a greater velocity in order to energize the diffuser endwall boundary layers so that they can sustain higher diffusion rates and levels.

### CROSS-REFERENCE TO RELATED APPLICATIONS

This application claims the benefit to U.S. Provisional Application 62/195,509 filed on Jul. 22, 2015 and entitled HIGH PRESSURE COMPRESSOR DIFFUSER FOR AN INDUSTRIAL GAS TURBINE ENGINE.

### GOVERNMENT LICENSE RIGHTS

This invention was made with Government support under contract number DE-FE0023975 awarded by Department of Energy. The Government has certain rights in the invention.

### BACKGROUND OF THE INVENTION

Field of the Invention

The present invention relates generally to an industrial gas turbine engine for electric power generation, and more specifically to an exit diffuser for a high pressure compressor (HPC) in which spent cooling air from a stator or a rotor of the turbine is injected into the HPC diffuser.

Description of the Related Art including information disclosed under 37 CFR 1.97 and 1.98

In a gas turbine engine, such as an industrial gas turbine engine, a diffuser is used to slow the velocity of compressed air exiting a compressor, which results in the pressure of the compressed air to increase for use in the combustor of the engine. FIG. 1 shows one prior art diffuser 12 for an industrial gas turbine engine downstream from a last stage guide vane 11 of a compressor. Diffused compressed air is then introduced into a combustor 13 to produce a hot gas stream that then flows through a turbine with a first stage stator vane 14. This prior art diffuser has walls with divergent angles of 5 and 6 degrees.

### BRIEF SUMMARY OF THE INVENTION

An HPC diffuser for a gas turbine engine in which spent cooling air from an air cooled turbine component such as a rotor blade or a stator vane is discharged into the HPC diffuser in a direction substantially parallel to the discharge from the HPC and at a greater velocity in order to energize the diffuser endwall boundary layers so they can sustain higher diffusion rates and levels than what they could in the prior art FIG. 1 diffuser.

### BRIEF DESCRIPTION OF THE SEVERAL VIEWS OF THE DRAWINGS

FIG. 1 shows a cross sectional view of a single spool engine compressor diffuser in an industrial gas turbine engine of the prior art.

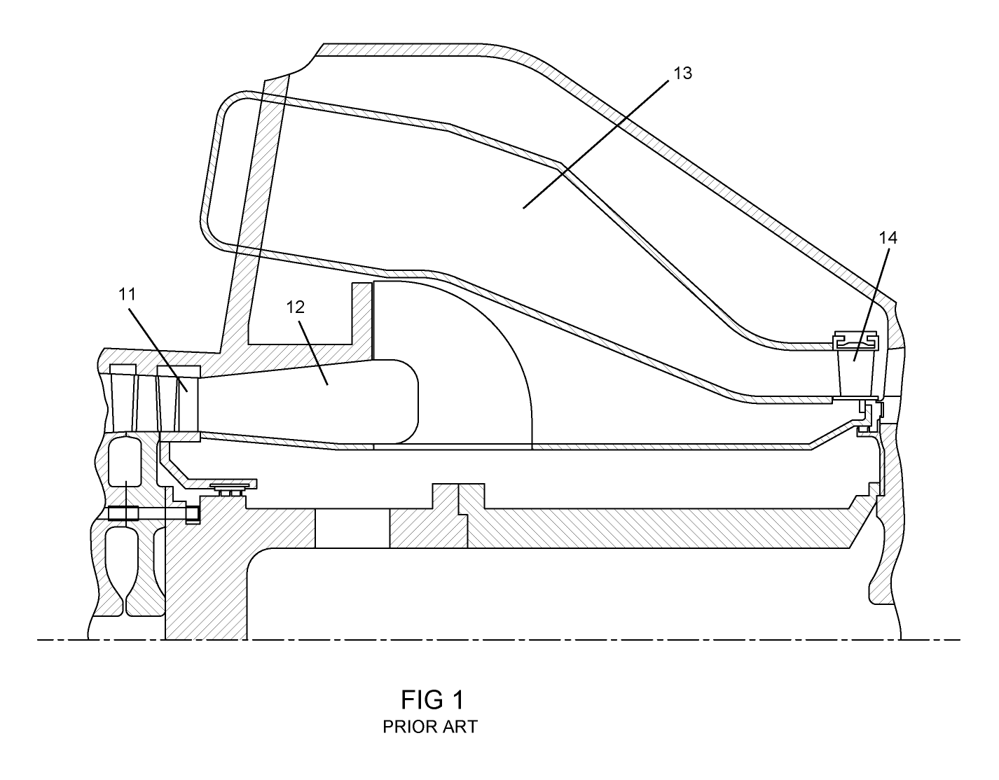

FIG. 2 shows a cross sectional view of a HPC diffuser of the present invention for use in an industrial gas turbine engine.

### DETAILED DESCRIPTION OF THE INVENTION

The present invention is a diffuser for a high pressure compressor (HPC) in a two spool industrial gas turbine engine in which cooling air is bled off from the low pressure compressor (LPC) and used to cool a hot part in the turbine, such as a stator vane, and where the cooling air is then reintroduced into the HPC diffuser air prior to entering the combustor. The HPC diffuser of the present invention allows for a greater rate and level of diffusion which can be used to achieve shorter length than prior art diffusers, greater diffusion in the same axial length, or a combination of reduced length and greater diffusion. Increased diffusion in the diffuser can also be used to reduce the required diffusion in the compressor which can increase its efficiency.

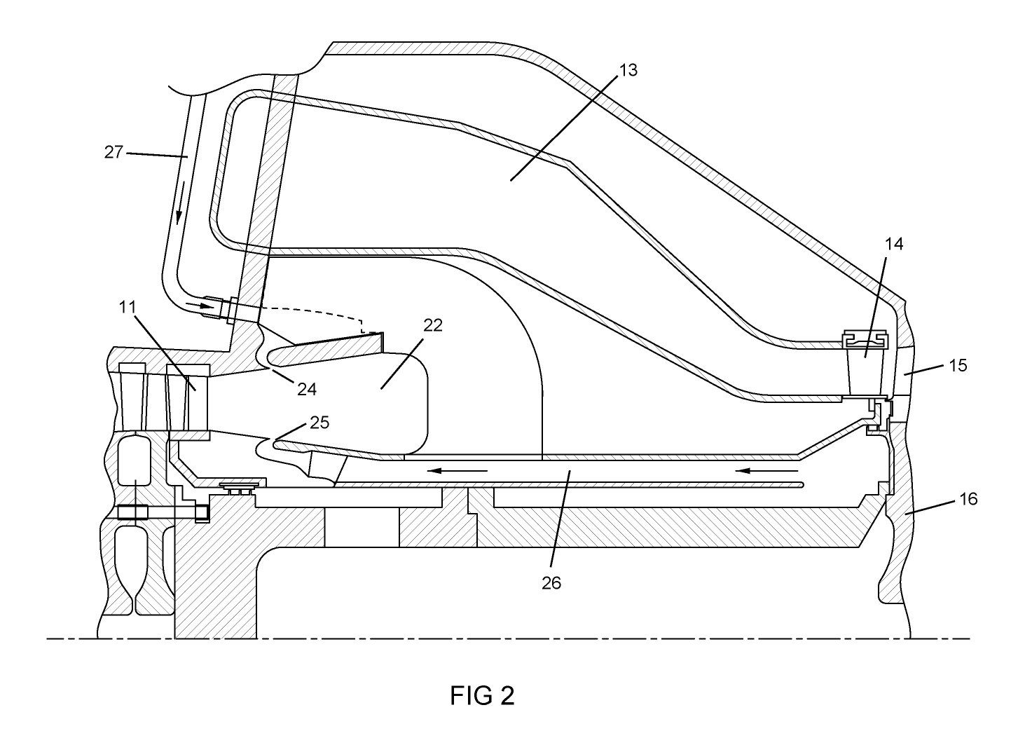

FIG. 2 shows an embodiment of the diffuser 22 of the present invention. The diffuser of the present invention is intended to be used in an industrial gas turbine engine that includes a low pressure spool and a high pressure spool but can also be used in an aero engine. Cooling air from the low pressure compressor is bled off and used to provide cooling to hot parts of the turbine such as the first stage stator vanes and even the rotor disk. This used or spent cooling air is then reintroduced into the compressed air from the HPC within the diffuser that then flows into the combustor 13 of the engine.

The HPC diffuser 22 has endwalls angled at about 8 degrees to increase total diffusion and allow for higher HPC exit Mach number and efficiency. Cooling air from a hot part of the engine (such as the turbine rotor blades) flows along the path 26 and then enters an inner turn channel 25 of the diffuser 22. Cooling air from another hot part (such as the turbine stator vanes) flows along path 27 and into an outer turn channel 24 of the diffuser 22. Flow velocities in paths 26 and 27 are kept low to minimize pressure loss. Turn channels 24 and 25 accelerate the cooling flow so that the discharge of the spent cooling air parallel to the diffuser endwalls energizes the diffuser endwall boundary layers allowing them to sustain higher diffusion rates and levels. Cooling air from the diffuser 22 then flows into the combustor 13 to be burned with a fuel and produce a hot gas stream that then flows through the turbine with a first stage stator vane 14 upstream from a first stage rotor blade 15 attached to a rotor disk 16. The spent cooling air from the rotor blade 15 or the stator vane 14 is injected at a higher velocity than the core flow from the compressor outlet has in the diffuser. A secondary compressor is used to increase the pressure of the cooling air that passes through the rotor blade 15 or the stator blade 14 prior to injecting the spent cooling air into the diffuser 22.

In the diffuser 22 of the embodiment in FIG. 2, the diffuser length is about 7 times the inlet height of the diffuser. The area ratio is around 3 to 3.5.

I claim the following:

1: A diffuser for a gas turbine engine in which compressed air from a compressor is decreased in velocity and increased in pressure prior to passage into a combustor, the diffuser comprising:
an inlet end to receive compressed air from the compressor and an outlet end to discharge compressed air at a higher pressure to a combustor;
an inner turn channel to receive compressed air from a first source and discharge the compressed air substantially parallel to the diffuser inner endwall; and,
an outer turn channel to receive compressed air from a second source and discharge the compressed air substantially parallel to the diffuser outer endwall.

2: The diffuser for a gas turbine engine of claim 1, and further comprising:
the diffuser has inner and outer endwalls angled at about 8 degrees from the engine centerline.

3: The diffuser for a gas turbine engine of claim 1, and further comprising:
the diffuser length is about 7 times the inlet height of the diffuser.

4: The diffuser for a gas turbine engine of claim 1, and further comprising:
the area ratio of the diffuser is around 3 to 3.5.

5: A gas turbine engine comprising:
a compressor to produce a compressed air flow;
a turbine to drive the compressor using a hot gas flow;
a combustor to produce the hot gas flow;
an air cooled component of the turbine;
a diffuser located between the compressor and the combustor to diffuse the compressed air flow from the combustor; and,
the diffuser having a turn channel to discharge spent cooling air from the air cooled turbine component into the diffuser at an angle substantially parallel to the diffuser endwall.

6: The gas turbine engine of claim 5, and further comprising:
the turbine includes a first air cooled component and a second air cooled component;
the diffuser includes an inner turn channel to receive spent cooling air from the first air cooled turbine component; and,
the diffuser includes an outer turn channel to receive spent cooling air from the second air cooled turbine component.

7: The gas turbine engine of claim 6, and further comprising:
the first air cooled turbine component is a turbine rotor blade; and,
the second air cooled turbine component is a turbine stator vane.

8: The gas turbine engine of claim 6, and further comprising:
the inner turn channel and the outer turn channel both discharge the spent cooling air into the compressed air flow from the compressor in directions substantially parallel to the inner and outer diffuser endwalls, respectively.

9: The gas turbine engine of claim 5, and further comprising:
the gas turbine engine is an industrial gas turbine engine; and,
the industrial gas turbine engine drives an electric generator to produce electrical power.
